(19) United States
(12) Patent Application Publication
(10) Pub. No.: US 2025/0259281 A1
(43) Pub. Date: Aug. 14, 2025

(54) TARGET ELEMENT GENERATION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Haoxiang FU, Beijing (CN); Junyu Zhang, Beijing (CN); Xinyi Wang, Beijing (CN); Meng Zhang, Beijing (CN); Junsheng Wu, Beijing (CN); Jiafei Guo, Beijing (CN)

(21) Appl. No.: 19/049,652

(22) Filed: Feb. 10, 2025

(30) Foreign Application Priority Data
Feb. 8, 2024 (CN) 202410178034.3

(51) Int. Cl. G06T 5/77

(52) U.S. Cl. CPC G06T 5/77

(57) ABSTRACT

A target element generation method and apparatus, an electronic device, and a storage medium are provided. The method includes: displaying an editing page on which a stylized image is displayed, where the stylized image is an image generated by performing target style conversion on an initial image; and displaying, in a target region of the stylized image, a target element corresponding to a processing operation for the target region in response to the processing operation for the target region, where the target element is an element generated by re-drawing the target region based on an initial element corresponding to the processing operation.

### CROSS-REFERENCE TO RELATED APPLICATION

The present disclosure claims priority of the Chinese Patent Application No. 202410178034.3 filed with the Chinese Patent Office on Feb. 8, 2024, the entire disclosure of which is incorporated by reference in the present disclosure.

### TECHNICAL FIELD

Embodiments of the present disclosure relate to artificial intelligence technology and, in particular, to a target element generation method and apparatus, an electronic device, and a storage medium.

### BACKGROUND

Augmented reality (AR) technology may be the technology that uses cameras or sensors to acquire images or scenes of the physical world, analyzes and understands them through computer vision and image processing technology, and superimposes virtual information on real scenes to achieve virtual-real fusion.

In the prior art, different users may be allowed to shoot images or videos by using the same AR prop, but the effects obtained by different users through this way are much the same, because the AR prop used for shooting is consistent, resulting in the content obtained by shooting being not rich enough.

### SUMMARY

The present disclosure provides a target element generation method and apparatus, an electronic device, and a storage medium, which can achieve an effect of enriching the content generated through drawing while conforming to a target style.

In a first aspect, an embodiment of the present disclosure provides a target element generation method, including:
displaying an editing page on which a stylized image is displayed, where the stylized image is an image generated by performing target style conversion on an initial image; and
displaying, in a target region of the stylized image, a target element corresponding to a processing operation for the target region in response to the processing operation for the target region, where the target element is an element generated by re-drawing the target region based on an initial element corresponding to the processing operation.

In a second aspect, an embodiment of the present disclosure further provides a target element generation apparatus, including:
a first display module, configured to display an editing page on which a stylized image is displayed, where the stylized image is an image generated by performing target style conversion on an initial image; and
a second display module, configured to display, in a target region of the stylized image, a target element corresponding to a processing operation for the target region in response to the processing operation for the target region, where the target element is an element generated by re-drawing the target region based on an initial element corresponding to the processing operation.

In a third aspect, an embodiment of the present disclosure further provides an electronic device, including:
one or more processing devices; and
a storage device configured to store one or more programs,
where the one or more programs, when executed by the one or more processing devices, cause the one or more processing devices to implement the target element generation method provided in the embodiments of the present disclosure.

In a fourth aspect, an embodiment of the present disclosure further provides a storage medium including computer-executable instructions, where the computer-executable instructions, when executed by a computer processor, cause the computer processor to execute the target element generation method provided in the embodiments of the present disclosure.

### BRIEF DESCRIPTION OF DRAWINGS

The above and other features, advantages and aspects of various embodiments of the present disclosure will become more apparent in combination with the drawings and with reference to the following detailed description. Throughout the drawings, the same or similar reference numerals denote the same or similar elements. It should be understood that the drawings are schematic and that parts and elements are not necessarily drawn to scale.

FIG. 1 is a schematic flowchart of a target element generation method according to an embodiment of the present disclosure;

FIG. 2 is a schematic flowchart of another target element generation method according to an embodiment of the present disclosure;

FIG. 3 is a schematic diagram of an editing page of a stylized image according to an embodiment of the present disclosure;

FIG. 4 is a schematic diagram of target style conversion according to an embodiment of the present disclosure;

FIG. 5 is a schematic structural diagram of a target element generation apparatus according to an embodiment of the present disclosure; and

FIG. 6 is a schematic structural diagram of an electronic device according to an embodiment of the present disclosure.

### DETAILED DESCRIPTION

Embodiments of the present disclosure are described in more detail below with reference to the drawings. The drawings illustrate some embodiments of the present disclosure, but it should be understood that the present disclosure may be implemented in various forms and should not be construed as limited to the embodiments set forth herein. Rather, these embodiments are provided for a thorough and complete understanding of the present disclosure. It should be understood that the drawings and the embodiments of the present disclosure are only for illustrative purposes, and are not intended to limit the protection scope of the present disclosure.

It should be understood that the various steps described in the method implementations of the present disclosure may be performed in different orders and/or in parallel. In addition, the method implementations may include additional steps and/or omit performing the illustrated steps. The scope of the present disclosure is not limited in this respect.

The term “include/comprise” and its variants as used herein are open-ended inclusions, that is, “include/comprise but not limited to”. The term “based on” is “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first” and “second” mentioned in the present disclosure are only used to distinguish between different devices, modules or units, and are not used to limit the order or interdependence of functions performed by these devices, modules or units.

It should be noted that the modifiers of “one” and “a plurality of” mentioned in the present disclosure are illustrative rather than restrictive, and those skilled in the art should understand that unless the context clearly indicates otherwise, they should be understood as “one or more”.

The names of messages or information exchanged between a plurality of devices in the implementations of the present disclosure are only for illustrative purposes, and are not intended to limit the scope of these messages or information.

It can be understood that before using the technical solutions disclosed in the embodiments of the present disclosure, the user should be informed of the type, scope of use, usage scenarios, etc. of personal information involved in the present disclosure in an appropriate manner in accordance with relevant laws and regulations, and the user's authorization should be obtained.

For example, in response to receiving an active request from a user, prompt information is sent to the user to clearly inform the user that the operation requested by the user will require the acquisition and use of the user's personal information. Thus, the user may choose, based on the prompt information, whether to provide the personal information to software or hardware such as an electronic device, an application, a server, or a storage medium that performs operations of the technical solutions of the present disclosure.

As an optional but non-limiting implementation, the manner of sending prompt information to the user in response to receiving the user's active request may be, for example, a pop-up window, in which the prompt information may be presented in text. In addition, the pop-up window may also carry a selection control for the user to choose whether to “agree” or “disagree” to provide the personal information to the electronic device.

It can be understood that the above process of notifying and acquiring the user's authorization is only illustrative, and does not constitute a limitation on the implementations of the present disclosure. Other manners that satisfy relevant laws and regulations may also be applied to the implementations of the present disclosure.

FIG. 1 is a schematic flowchart of a target element generation method according to an embodiment of the present disclosure. The embodiment of the present disclosure is applicable to the case of locally re-drawing a stylized image, and the method may be executed by a target element generation apparatus, which may be implemented in the form of software and/or hardware and integrated in an electronic device. Optionally, the electronic device may be a mobile terminal or a PC terminal.

As shown in FIG. 1, the method includes:
S110: displaying an editing page on which a stylized image is displayed, where the stylized image is an image generated by performing target style conversion on an initial image.

In this step, the initial image may be an original image that has not been subjected to style conversion. The initial image may be an image obtained by real scene shooting, or an image acquired through a server or a webpage, or an image captured from a video filmed in a real scene, which is not limited herein. The initial image may be an image including a person, an animal, a building, or a natural landscape, etc.

The stylized image may be an image generated by performing target style conversion on the initial image. In order to make the initial image conform to the target style, the initial image may be converted into the stylized image conforming to the target style through artificial intelligence generative content (AIGC) technology, and all content included in the initial image may be converted during the style conversion. The target style may be a style determined according to actual needs, such as a style related to a certain animation element, game, or dynasty, which is not limited herein.

The editing page may be a page for editing the stylized image. By displaying the editing page, the stylized image may be locally re-drawn subsequently.

S120: displaying, in a target region of the stylized image, a target element corresponding to a processing operation for the target region in response to the processing operation for the target region, where the target element is an element generated by re-drawing the target region based on an initial element corresponding to the processing operation.

The target region may be a region in the stylized image that needs to be re-drawn, such as a part or all of the region in the stylized image, which is not limited herein.

The processing operation for the target region may be an operation of determining the target region on the stylized image. The processing operation for the target region may also be an operation of determining the target region on the stylized image and determining the initial element used to re-draw the target region.

The initial element may be an element used to re-draw the target region, and the initial element may be related to the content included in the target region, so as to make the content displayed in the target region richer. The target element may be an element obtained by re-drawing the target region based on the initial element, for example, the initial element is fused and displayed into the content included in the target region to obtain the target element through the AIGC technology.

In an embodiment, the processing operation for the target region is an operation of determining the target region on the stylized image, such as an operation of the user selecting a part or all of the region in the stylized image through framing, and the selected region by framing is exactly the target region. In response to the processing operation for the target region on the stylized image, the target region may be determined, and the target region is re-drawn based on the initial element to obtain the target element through the AIGC technology, and the target element is displayed. At this time, the initial element corresponding to the processing operation may be a certain element automatically recommended for the content included in the target region, for example, if the target region includes a cat, clothes or hats suitable for the cat may be automatically recommended as the initial element.

In an embodiment, the processing operation for the target region is an operation of determining the target region on the stylized image and determining the initial element used to re-draw the target region, such as an operation of the user selecting the target region by framing in the stylized image, and after obtaining the target region, automatically displaying multiple elements automatically recommended for the content included in the target region for the user to choose from, and the user may choose one of the elements as the initial element. In response to the processing operation for the target region on the stylized image, the target region may be determined, and the target region is re-drawn based on the selected initial element to obtain the target element through the AIGC technology, and the target element is displayed.

Embodiments of the present disclosure provide a target element generation method and apparatus, an electronic device, and a storage medium. The method includes: displaying an editing page on which a stylized image is displayed, where the stylized image is an image generated by performing target style conversion on an initial image; and displaying, in a target region of the stylized image, a target element corresponding to a processing operation for the target region in response to the processing operation for the target region, where the target element is an element generated by re-drawing the target region based on an initial element corresponding to the processing operation. According to the above technical solution, on the basis of the stylized image that conforms to a target style, the target region on the stylized image is locally re-drawn through the processing operation for the target region. Differences in the target region corresponding to the processing operation or differences in the initial element corresponding to the processing operation both will affect the generation of the target element during re-drawing, thereby achieving an effect of enriching the content generated through drawing while conforming to the target style.

On the basis of the above embodiments, variant embodiments of the above embodiments are proposed. It should be noted here that, in order to make the description brief, only the differences from the above embodiments are described in the variant embodiments.

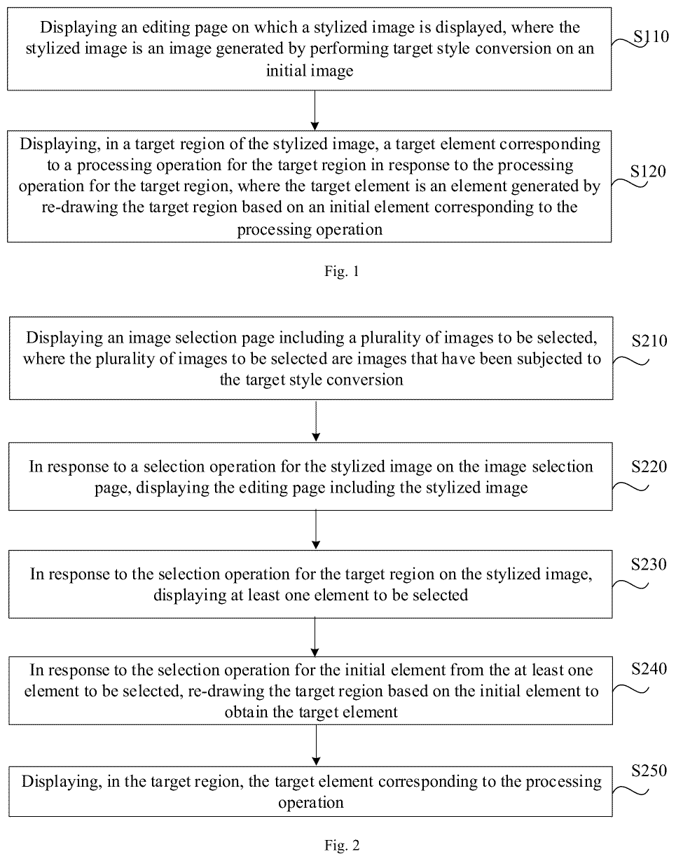

FIG. 2 is a schematic flowchart of another target element generation method according to an embodiment of the present disclosure, and the embodiment of the present disclosure is a further refinement of the above embodiments. As shown in FIG. 2, the method includes:

One implementation of displaying the editing page is described below through the following steps S210 and S220.

S210: displaying an image selection page including a plurality of images to be selected, where the plurality of images to be selected are images that have been subjected to the target style conversion.

S220: in response to a selection operation for the stylized image on the image selection page, displaying the editing page including the stylized image.

The image selection page may be a page for determining the stylized image. The image to be selected may be an image to be selected as the stylized image. The image selection page includes a plurality of images to be selected, and the plurality of images to be selected may be images obtained by performing target style conversion on different images as collected, and the content included in different images to be selected may be different, but they all conform to the target style.

The selection operation for the stylized image may be an operation of selecting the stylized image from the plurality of images to be selected, such as an operation of clicking on a certain image to be selected, and the image to be selected being clicked is the stylized image for which part of the content is to be re-drawn. After selecting the stylized image through the selection operation for the stylized image, the display of the editing page including the stylized image may be triggered.

In a case that the processing operation includes the selection operation for the target region and the selection operation for the initial element, the displaying, in the target region of the stylized image, the target element corresponding to the processing operation for the target region in response to the processing operation for the target region is further refined and described below through the following steps S230 to S250. The initial element is an element to be fused to the target region.

S230: in response to the selection operation for the target region on the stylized image, displaying at least one element to be selected.

The selection operation of the target region may be an operation of selecting the target region on the stylized image, and the user may select the target region on the stylized image through framing or the like. In response to the selection operation for the target region on the stylized image, the target region may be determined and the at least one element to be selected may be displayed. The at least one element to be selected may be displayed in the form of a panel or a pop-up window, which is not limited herein.

The element to be selected is an element to be selected for re-drawing the target region, the number of the element to be selected may be one or more, and the element to be selected may be an element automatically recommended based on the content in the target region.

In an embodiment, in response to the selection operation for the target region on the stylized image, displaying the at least one element to be selected, including:
in response to the selection operation for the target region on the stylized image, identifying content displayed in the target region to obtain an identification result; and
displaying at least one element to be selected that is related to the identification result.

In response to the selection operation for the target region on the stylized image, the target region may be determined, and the identification result corresponding to the content included in the target region may be identified through a certain identification algorithm. The identification result may be a result of a category corresponding to the content included in the target region, such as a person, an animal, a plant, a building, etc., or a refined category of the foregoing categories.

After the identification result is determined, at least one different element to be selected may be recommended and displayed according to different identification results. Exemplarily, when the identification result indicates that the category corresponding to the content included in the target region is a person, the element to be selected may be clothes; when the identification result indicates that the category corresponding to the content included in the target region is a building, the element to be selected may be a decoration for the building, such as a “Fu” character.

S240: in response to the selection operation for the initial element from the at least one element to be selected, re-drawing the target region based on the initial element to obtain the target element.

The selection operation for the initial element may be an operation of selecting one of the at least one element to be selected, the element to be selected as selected is exactly the initial element, and the initial element is used to be fused to the target region.

In response to the selection operation for the initial element from the at least one element to be selected, the initial element may be determined, and the target region is re-drawn based on the determined initial element through the AIGC technology, so as to fuse the initial element into the content included in the target region.

S250: displaying, in the target region, the target element corresponding to the processing operation.

According to the technical solution of the embodiment of the present disclosure, the user may be provided with a plurality of images to be selected through the image selection page, and the user may select one of the images to be selected as the stylized image, so that the stylized image is more selectable while conforming to the target style. The user may independently select a region that needs to be re-drawn through the selection operation for the target region on the stylized image, and the user may select the initial element used for re-drawing through the selection operation for the initial element, and then re-draw the target region based on the initial element to obtain the target element and display the target element, thereby realizing the personalized local re-drawing of the stylized image.

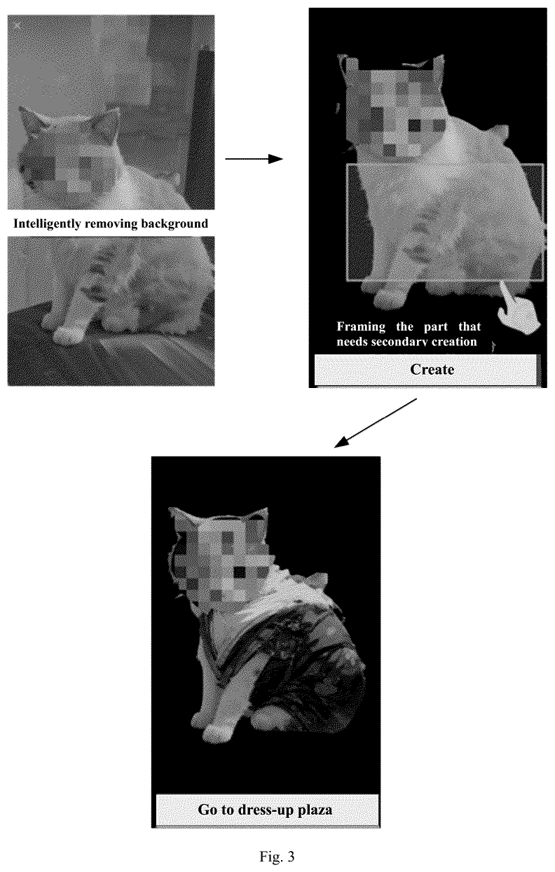

FIG. 3 is a schematic diagram of an editing page of a stylized image according to an embodiment of the present disclosure. As shown in FIG. 3, a stylized image with a cat as a subject is shown at the upper left corner, and the background of the image is intelligently removed to obtain a background-removed stylized image shown at the upper right corner in FIG. 3. On the basis of the background-removed stylized image, the user may determine a part that needs to be subjected to a secondary creation by framing (i.e., determine the target region through the selection operation for the target region). At the same time of determining the target region, the at least one element to be selected may be displayed in the form of a pop-up window or a panel (not shown in FIG. 3), and the user may determine the initial element through the selection operation for the initial element, and the initial element may be clothes suitable for the cat. After determining the initial element, in response to clicking on the “creation” control in the image at the upper right corner shown in FIG. 3, the operation of re-drawing the target region of the stylized image based on the initial element may be triggered to obtain the target element shown in the lower part of FIG. 3. The target element is fused with the initial element and the content included in the target region before re-drawing. The “creation” control may be a control used to trigger re-drawing.

In an embodiment, another implementation of displaying the editing page is provided, and the displaying the editing page includes:
displaying an image selection page including a plurality of images to be selected, where the plurality of images to be selected are images that have been subjected to the target style conversion;
in response to a trigger operation for a shooting control in the image selection page, shooting the initial image;
obtaining the stylized image corresponding to the initial image; and
displaying the editing page including the stylized image.

A shooting control may also be displayed on the image selection page, and the shooting control is used to trigger shooting of the initial image. In response to the trigger operation for the shooting control (that is, the operation of triggering the shooting control), the initial image may be obtained by shooting; after obtaining the initial image, the target style conversion may be performed on the initial image to obtain the stylized image; and the editing page including the stylized image is displayed. The advantage of this setting is that a shooting entry of the initial image may be reserved for the user, and then the initial image may be shot according to actual needs and then the style conversion may be performed, so that the selectable stylized images are more abundant.

In the embodiment of the present disclosure, the shooting entry of the initial image is not limited to be in the image selection page, and may also be in the target world page. The target world page may be a page associated with the target style, which may be understood as a page corresponding to a hall for participating in an activity. The target world page may provide the user with a shooting entry of the initial image, a local re-drawing entry of the stylized image, a display entry of the re-drawn stylized image, etc., which is not limited herein.

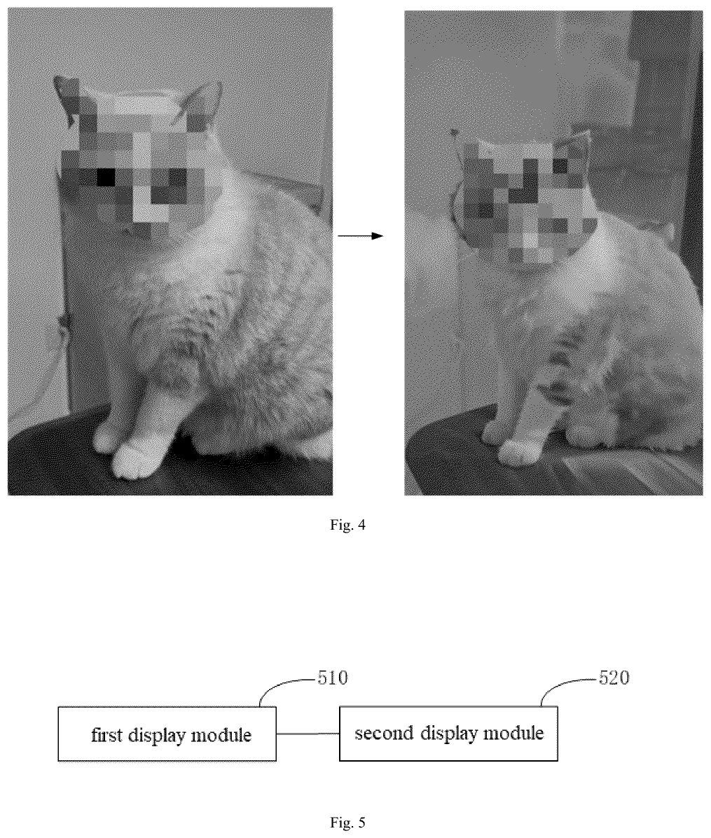

FIG. 4 is a schematic diagram of target style conversion according to an embodiment of the present disclosure. The left side of FIG. 4 may be understood as a page triggered to be displayed through a shooting entry of any initial image. A schematic diagram of shooting an initial image in a real scene is shown at the left side of FIG. 4 is, and the shooting of the initial image may be triggered through this page. After shooting the initial image, the target style conversion may be automatically performed on the shot image to obtain a stylized image shown at the right side of FIG. 4. It can be seen from FIG. 4 that the stylized image has richer colors and its overall style has changed, as compared with the initial image.

In an embodiment, the displaying the image selection page includes:
displaying a target world page, where a style of the target world page is associated with the target style; and
in response to a trigger operation for a creation control in the target world page, displaying the image selection page.

The target world page may be a page associated with the target style, which may be understood as a page corresponding to a hall for participating in an activity. The target world is a virtual world in the activity, such as a game world. The creation control may be a control in the target world page that triggers the display of the image selection page. In response to the trigger operation for the creation control in the target world page (that is, the operation of triggering the creation control), the image selection page may be displayed. The advantage of this setting is that a display entry of the image selection page may be provided in the target world page, which is convenient for displaying a plurality of stylized images to be selected in the image selection page, or shooting the initial image and then performing the style conversion.

In an embodiment, the obtaining the stylized image corresponding to the initial image includes:
determining scene information of the initial image;
transmitting the scene information and the initial image to a target end; and
obtaining, from the target end, the stylized image corresponding to the scene information and the initial image.

The scene information of the initial image may be understood as scene-related information of the initial image. The scene information may be related to a category corresponding to the content included in the initial image, such as a person, an animal, a plant, a building, etc., or a refined category of the foregoing categories.

Exemplarily, for 22 different categories, they may be grouped into 10 different scenes. Each scene corresponds to a piece of scene information, and the scene information may include guidance words required for stylization processing in this scene, and some parameters required for stylization, etc. The guidance words required for the stylization processing and some parameters required for the stylization may be determined according to the target style, which is not limited herein.

The target end may be an end for performing stylization processing, which is not limited herein. At the target end, the stylization conversion may be performed on the initial image based on the scene information and the initial image through the AIGC technology to obtain the stylized image.

In an embodiment, the method further includes:
adding the stylized image with the re-drawn target region to the target world page.

The stylized image with the re-drawn target region is shown at the lower part of FIG. 3, and a target world page may be entered and the stylized image may be added to the target world page by clicking on the “go to dress-up plaza” control. When adding, the user may actively control the display manner of the stylized image in the target world page, for example, adjust its display position by flipping or dragging. The “go to dress-up plaza” control may be a control used to trigger the entry into the target world page.

The technical solutions of the embodiments of the present disclosure are exemplarily illustrated below in conjunction with actual application scenarios.

In an actual scenario, the user may participate in an activity corresponding to the target world page through an applet, and the process includes: shooting things or scenes (i.e., the initial image) around the user, and performing target style conversion on the shot content by using the capability of AIGC, so that a real-word image is converted into an image of the target style; selecting a creation target in the stylized image for local re-drawing (i.e., determining the subject for local re-drawing and the target region for local re-drawing); and displaying, sharing and ranking the results obtained through local re-drawing (i.e., the creation results) in the hall of the target world page. This solution may achieve the purpose of making diverse creations while conforming to the target style.

For the display of the target world page, that is, the entrance for participating in the activity, it may be triggered to enter through an applet or an application, such as an anchor displayed in a short video application (for example, it may be entered by triggering an anchor displayed in a page for realizing video browsing in the short video application), and it may also be triggered to enter by searching for keywords of the activity in the applet or the application, which is not limited here. The short video application may be an application for realizing short video interaction, such as creating, editing and sharing short video content through the application. The duration of the short video is within a set duration, for example, between a few seconds and a few minutes.

In the process of entering the target world page, the user may be guided by prompting, such as texts or cartoon characters, to operate to enter the activity.

After entering the target world page, the user may browse the activity venue, and may also trigger creation through a certain control, for example, trigger to enter a page for shooting the initial image, and trigger to enter the image selection page.

In the page for shooting the initial image, the initial image may be shot and the style conversion may be performed to obtain the stylized image. The stylized image may be saved in the image selection page for the user to view, or the editing page of the stylized image may be directly entered for local re-drawing.

In the image selection page, the stylized image that needs to be re-drawn may be determined by clicking on any image to be selected, and the display of the editing page of the stylized image may be triggered for local re-drawing; or the entry into the page for shooting the initial image may be triggered. After the local re-drawing is completed, the result obtained through the local re-drawing may be added to the target world page for display.

The style conversion of the initial image may be implemented through the following steps:

Shooting the initial image by a shooter; determining a category corresponding to content included in the initial image through an algorithm used for scene classification, and further determining scene information corresponding to the initial image (such as guidance words or parameters required for generating the target style, etc.), where the category includes baby, beach, building, car, cartoon, cat, dog, flower, food, co-production, mountain, interior, lake (including sea), night scene, selfie, sky, sculpture, street view, sunset, text, tree, etc.; transmitting the scene information and the initial image to a target end; obtaining, from the target end, a stylized image corresponding to the scene information and the initial image; uploading, publishing, and sharing the stylized image.

The local re-drawing may be summarized as the following steps:
matting the stylized image; determining a target region on the stylized image and an initial element used for re-drawing; re-drawing the target region based on the initial element to obtain a target element; adding the result obtained through re-drawing to the target world page for display.

The results obtained through re-drawing in the target world page may be displayed in a ranking list, which may include the following steps:
acquiring a plurality of identifiers that publish the results obtained through re-drawing; performing filtering according to conditions such as keywords and popularity to obtain the ranking list, or performing intelligent recommendation to form the ranking list. In the ranking list, the results obtained through re-drawing by a plurality of different users may be displayed in ranking, and the user may give a like to the results in the ranking list, which is more conducive to driving the user to participate in the activity.

FIG. 5 is a schematic structural diagram of a target element generation apparatus according to an embodiment of the present disclosure. As shown in FIG. 5, the apparatus includes: a first display module 510 and a second display module 520.

The first display module 510 is configured to display an editing page on which a stylized image is displayed, where the stylized image is an image generated by performing target style conversion on an initial image; and

The second display module 520 is configured to display, in a target region of the stylized image, a target element corresponding to a processing operation for the target region in response to the processing operation for the target region, where the target element is an element generated by re-drawing the target region based on an initial element corresponding to the processing operation.

According to the technical solution provided in the embodiment of the present disclosure, the first display module displays an editing page on which a stylized image is displayed, where the stylized image is an image generated by performing target style conversion on an initial image; and the second display module displays, in a target region of the stylized image, a target element corresponding to a processing operation for the target region in response to the processing operation for the target region, where the target element is an element generated by re-drawing the target region based on an initial element corresponding to the processing operation. According to the above technical solution, on the basis of the stylized image that conforms to a target style, the target region on the stylized image is locally re-drawn in response to the processing operation for the target region. Differences in the target region corresponding to the processing operation or differences in the initial element corresponding to the processing operation both will affect the generation of the target element during re-drawing, thereby achieving an effect of enriching the content generated through drawing while conforming to the target style.

In an embodiment, the processing operation includes a selection operation for the target region and a selection operation for the initial element, where the initial element is an element to be fused to the target region, and correspondingly,
the second display module 520 can be configured to:
in response to the selection operation for the target region on the stylized image, display at least one element to be selected;
in response to the selection operation for the initial element from the at least one element to be selected, re-draw the target region based on the initial element to obtain the target element; and
display, in the target region, the target element corresponding to the processing operation.

In an embodiment, the second display module 520 can be configured to:
in response to the selection operation for the target region on the stylized image, identify content displayed in the target region to obtain an identification result; and
display at least one element to be selected that is related to the identification result.

In an embodiment, the first display module 510 can be configured to:
display an image selection page including a plurality of images to be selected, where the plurality of images to be selected are images that have been subjected to the target style conversion; and
in response to a selection operation for the stylized image on the image selection page, display the editing page including the stylized image.

In an embodiment, the first display module 510 can be configured to:
display an image selection page including a plurality of images to be selected, where the plurality of images to be selected are images that have been subjected to the target style conversion;
in response to a trigger operation for a shooting control in the image selection page, shoot the initial image;
obtain the stylized image corresponding to the initial image; and
display the editing page including the stylized image.

In an embodiment, the first display module 510 can be configured to:
display a target world page, where a style of the target world page is associated with the target style; and
in response to a trigger operation for a creation control in the target world page, display the image selection page.

In an embodiment, the first display module 510 can be configured to:
determine scene information of the initial image;
transmit the scene information and the initial image to a target end; and
obtain, from the target end, the stylized image corresponding to the scene information and the initial image.

In an embodiment, the apparatus further includes:
an adding module configured to add the stylized image with the re-drawn target region to the target world page.

The target element generation apparatus provided in the embodiment of the present disclosure may execute the target element generation method provided in any embodiment of the present disclosure, and has corresponding functional modules and beneficial effects for executing the method.

It should be noted that the units and modules included in the above apparatus are only divided according to functional logic, but are not limited to the above division, as long as the corresponding functions can be realized. In addition, the specific names of the functional units are only for the convenience of distinguishing from each other, and are not used to limit the protection scope of the embodiments of the present disclosure.

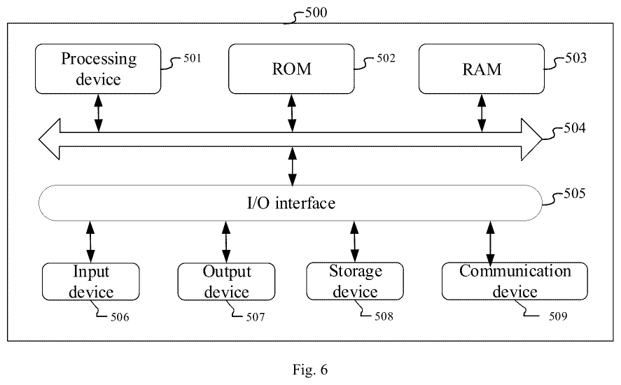

FIG. 6 is a schematic structural diagram of an electronic device according to an embodiment of the present disclosure. Reference is made to FIG. 6 below, which illustrates a schematic structural diagram of an electronic device 500 (such as a terminal device or a server in FIG. 6) suitable for implementing the embodiments of the present disclosure.

An electronic device provided in an embodiment of the present disclosure includes:
one or more processing devices; and
a storage device configured to store one or more programs,
where the one or more programs, when executed by the one or more processing devices, cause the one or more processing devices to implement the target element generation method provided in any embodiment of the present disclosure.

The terminal device in the embodiment of the present disclosure may include, but is not limited to, mobile terminals such as a mobile phone, a notebook computer, a digital broadcast receiver, a PDA (Personal Digital Assistant), a PAD (tablet computer), a PMP (Portable Multimedia Player), a vehicle-mounted terminal (such as a vehicle-mounted navigation terminal), etc., and fixed terminals such as a digital TV, a desktop computer, etc. The electronic device shown in FIG. 6 is only an example, and should not bring any limitation to the function and scope of use of the embodiments of the present disclosure.

As shown in FIG. 6, the electronic device 500 may include a processing device (such as a central processing unit, a graphics processing unit, etc.) 501, which may perform various appropriate actions and processes according to a program stored in a read-only memory (ROM) 502 or a program loaded from a storage device 508 into a random-access memory (RAM) 503. The RAM 503 also stores various programs and data required for the operation of the electronic device 500. The processing device 501, the ROM 502 and the RAM 503 are connected to each other through a bus 504. An edit/output (I/O) interface 505 is also connected to the bus 504.

Generally, the following devices may be connected to the I/O interface 505: an input device 506 including, for example, a touch screen, a touch pad, a keyboard,, a mouse, a camera, a microphone, an accelerometer, a gyroscope, etc.; an output device 507 including, for example, a liquid crystal display (LCD), a speaker, a vibrator, etc.; a storage device 508 including, for example, a magnetic tape, a hard disk, etc.; and a communication device 509. The communication device 509 may allow the electronic device 500 to perform wireless or wired communication with other devices to exchange data. Although FIG. 6 shows the electronic device 500 having various devices, it should be understood that not all of the illustrated devices are required to be implemented or provided. More or fewer devices may alternatively be implemented or provided.

In particular, according to an embodiment of the present disclosure, the process described above with reference to the flowchart may be implemented as a computer software program. For example, an embodiment of the present disclosure includes a computer program product including a computer program carried on a non-transitory computer readable medium, the computer program including program codes for executing the method shown in the flowchart. In such an embodiment, the computer program may be downloaded and installed from a network through the communication device 509, or installed from the storage device 508, or installed from the ROM 502. When the computer program is executed by the processing device 501, the above functions defined in the method of the embodiments of the present disclosure are performed.

The names of messages or information exchanged between a plurality of devices in the implementations of the present disclosure are only for illustrative purposes, and are not intended to limit the scope of these messages or information.

The electronic device provided in the embodiment of the present disclosure and the target element generation method provided in the above embodiments belong to the same inventive concept. For technical details not described in detail in this embodiment, reference may be made to the above embodiments, and this embodiment has the same beneficial effects as the above embodiments.

An embodiment of the present disclosure provides a computer storage medium on which a computer program is stored, and when the program is executed by a processor, the target element generation method provided in the above embodiments is implemented.

It should be noted that the above computer-readable medium in the present disclosure may be a computer-readable signal medium or a computer-readable storage medium, or any combination of the above two.

The computer storage medium may be a storage medium for computer-executable instructions, and the computer-executable instructions, when executed by a computer processor, cause the computer processor to execute the method provided in the present disclosure.

The computer-readable storage medium may be, for example, but not limited to, an electronic, magnetic, optical, electromagnetic, infrared, or semiconductor system, apparatus, or device, or any combination of the above. More specific examples of the computer-readable storage medium may include, but are not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal that propagates in a baseband or as a part of a carrier, and carries computer-readable program codes. The data signal propagating in this way may take a variety of forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit the program used by or in combination with the instruction execution system, apparatus, or device. The program codes contained on the computer-readable medium may be transmitted by any suitable medium, including but not limited to: electric wires, optical cables, RF (radio frequency), etc., or any suitable combination of the above.

In some implementations, clients and servers may communicate using any currently known or future developed network protocol, such as HTTP (HyperText Transfer Protocol), and may be interconnected with digital data communication (for example, communication networks) in any form or medium. Examples of communication networks include local area networks (“LAN”), wide area networks (“WAN”), international network (for example, the Internet), and end-to-end networks (for example, ad hoc end-to-end networks), as well as any currently known or future developed networks.

The above computer-readable medium may be included in the above electronic device, or may exist alone without being assembled into the electronic device.

The above computer-readable medium carries one or more programs, and when the above one or more programs are executed by the electronic device, the electronic device is caused to: display an editing page on which a stylized image is displayed, where the stylized image is an image generated by performing target style conversion on an initial image; and display, in a target region of the stylized image, a target element corresponding to a processing operation for the target region in response to the processing operation for the target region, where the target element is an element generated by re-drawing the target region based on an initial element corresponding to the processing operation.

Computer program codes for performing the operations of the present disclosure may be written in one or more programming languages or a combination thereof. The above programming languages include object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the case of the remote computer, the remote computer may be connected to the user's computer through any kind of network, including a local area network (LAN) or a wide area network (WAN), or may be connected to an external computer (for example, via the Internet through an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may be implemented by a combination of dedicated hardware and computer instructions.

The modules or units involved in the embodiments of the present disclosure may be implemented in software or hardware. The name of the module or unit does not constitute a limitation on the unit itself under certain circumstances.

The functions described herein above may be performed, at least partially, by one or more hardware logic components. For example, without limitation, exemplary types of hardware logic components that can be used include: a field programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, Example 1 provides a target element generation method, including:
displaying an editing page on which a stylized image is displayed, where the stylized image is an image generated by performing target style conversion on an initial image; and
displaying, in a target region of the stylized image, a target element corresponding to a processing operation for the target region in response to the processing operation for the target region, where the target element is an element generated by re-drawing the target region based on an initial element corresponding to the processing operation.

According to one or more embodiments of the present disclosure, Example 2 is the method according to Example 1,
where the processing operation includes a selection operation for the target region and a selection operation for the initial element, where the initial element is an element to be fused to the target region, and correspondingly,
the displaying, in the target region of the stylized image, the target element corresponding to the processing operation for the target region in response to the processing operation for the target region includes:
in response to the selection operation for the target region on the stylized image, displaying at least one element to be selected;
in response to the selection operation for the initial element from the at least one element to be selected, re-drawing the target region based on the initial element to obtain the target element; and
displaying, in the target region, the target element corresponding to the processing operation.

According to one or more embodiments of the present disclosure, Example 3 is the method according to Example 2,
where the in response to the selection operation for the target region on the stylized image, displaying the at least one element to be selected includes:
in response to the selection operation for the target region on the stylized image, identifying content displayed in the target region to obtain an identification result; and
displaying at least one element to be selected that is related to the identification result.

According to one or more embodiments of the present disclosure, Example 4 is the method according to Example 1,
where the displaying an editing page includes:
displaying an image selection page including a plurality of images to be selected, where the plurality of images to be selected are images that have been subjected to the target style conversion; and
in response to a selection operation for the stylized image on the image selection page, displaying the editing page including the stylized image.

According to one or more embodiments of the present disclosure, Example 5 is the method according to Example 1,
where the displaying an editing page includes:
displaying an image selection page including a plurality of images to be selected, where the plurality of images to be selected are images that have been subjected to the target style conversion;
in response to a trigger operation for a shooting control in the image selection page, shooting the initial image;
obtaining the stylized image corresponding to the initial image; and
displaying the editing page including the stylized image.

According to one or more embodiments of the present disclosure, Example 6 is the method according to Example 4 or 5,
where the displaying an image selection page includes:
displaying a target world page, where a style of the target world page is associated with the target style; and
in response to a trigger operation for a creation control in the target world page, displaying the image selection page.

According to one or more embodiments of the present disclosure, Example 7 is the method according to Example 5,
where the obtaining the stylized image corresponding to the initial image includes:
determining scene information of the initial image;
transmitting the scene information and the initial image to a target end; and
obtaining, from the target end, the stylized image corresponding to the scene information and the initial image.

According to one or more embodiments of the present disclosure, Example 8 is the method according to Example 1, further including:
adding the stylized image with the re-drawn target region to the target world page.

According to one or more embodiments of the present disclosure, Example 9 provides a target element generation apparatus, including:
a first display module configured to display an editing page on which a stylized image is displayed, where the stylized image is an image generated by performing target style conversion on an initial image; and
a second display module configured to display, in a target region of the stylized image, a target element corresponding to a processing operation for the target region in response to the processing operation for the target region, where the target element is an element generated by re-drawing the target region based on an initial element corresponding to the processing operation.

According to one or more embodiments of the present disclosure, Example 10 provides an electronic device, the electronic device including:
one or more processing devices; and
a storage device configured to store one or more programs,
where the one or more programs, when executed by the one or more processing devices, cause the one or more processing devices to implement the target element generation method according to any one of Examples 1 to 8.

According to one or more embodiments of the present disclosure, Example 11 provides a storage medium including computer-executable instructions, where the computer-executable instructions, when executed by a computer processor, cause the computer processor to execute the target element generation method according to any one of Examples 1 to 8.

The above description is only preferred embodiments of the present disclosure and an illustration of the applied technical principles. Those skilled in the art should understand that the scope of disclosure involved in the present disclosure is not limited to the technical solutions formed by the specific combination of the above-mentioned technical features, but should also cover other technical solutions formed by any combination of the above-mentioned technical features or their equivalent features without departing from the above-mentioned disclosed concept. For example, a technical solution formed by replacing the above features with technical features having similar functions disclosed in the present disclosure (but not limited to).

In addition, although operations are depicted in a particular order, this should not be understood as requiring that the operations be performed in the specific order as shown or in a sequential order. Under certain circumstances, multitasking and parallel processing may be advantageous. Similarly, although several specific implementation details are included in the above discussion, these should not be construed as limiting the scope of the present disclosure. Certain features that are described in the context of separate embodiments can also be implemented in combination in a single embodiment. Conversely, various features described in the context of a single embodiment may also be implemented in multiple embodiments separately or in any suitable sub-combination.

Although the subject matter has been described in a language specific to structural features and/or method logical actions, it should be understood that the subject matter defined in the appended claims is not necessarily limited to the specific features or actions described above. On the contrary, the specific features and actions described above are only example forms for implementing the claims.

1. A target element generation method, comprising:
displaying an editing page on which a stylized image is displayed, wherein the stylized image is an image generated by performing target style conversion on an initial image; and
displaying, in a target region of the stylized image, a target element corresponding to a processing operation for the target region in response to the processing operation for the target region, wherein the target element is an element generated by re-drawing the target region based on an initial element corresponding to the processing operation.

2. The method according to claim 1, wherein the processing operation comprises a selection operation for the target region and a selection operation for the initial element, wherein the initial element is an element to be fused to the target region,
the displaying, in the target region of the stylized image, the target element corresponding to a processing operation for the target region in response to the processing operation for the target region comprises:
in response to the selection operation for the target region on the stylized image, displaying at least one element to be selected;
in response to the selection operation for the initial element from the at least one element to be selected, re-drawing the target region based on the initial element to obtain the target element; and
displaying, in the target region, the target element corresponding to the processing operation.

3. The method according to claim 2, wherein displaying the at least one element to be selected in response to the selection operation for the target region on the stylized image comprises:
in response to the selection operation for the target region on the stylized image, identifying content displayed in the target region to obtain an identification result; and
displaying the at least one element to be selected that is related to the identification result.

4. The method according to claim 1, wherein displaying the editing page comprises:
displaying an image selection page comprising a plurality of images to be selected, wherein the plurality of images to be selected are images that have been subjected to the target style conversion; and
in response to a selection operation for the stylized image on the image selection page, displaying the editing page comprising the stylized image.

5. The method according to claim 1, wherein displaying the editing page comprises:
displaying an image selection page comprising a plurality of images to be selected, wherein the plurality of images to be selected are images that have been subjected to the target style conversion;
in response to a trigger operation for a shooting control in the image selection page, shooting the initial image;
obtaining the stylized image corresponding to the initial image; and
displaying the editing page comprising the stylized image.

6. The method according to claim 4, wherein displaying the image selection page comprises:
displaying a target world page, wherein a style of the target world page is associated with the target style; and
in response to a trigger operation for a creation control in the target world page, displaying the image selection page.

7. The method according to claim 5, wherein obtaining the stylized image corresponding to the initial image comprises:
determining scene information of the initial image;
transmitting the scene information and the initial image to a target end; and
obtaining, from the target end, the stylized image corresponding to the scene information and the initial image.

8. The method according to claim 1, further comprising:
adding the stylized image with the re-drawn target region to a target world page.

9. An electronic device, comprising:
one or more processing devices; and
a storage device configured to store one or more programs,
wherein the one or more programs, when executed by the one or more processing devices, cause the one or more processing devices to implement a target element generation method, comprising:
displaying an editing page on which a stylized image is displayed, wherein the stylized image is an image generated by performing target style conversion on an initial image; and
displaying, in a target region of the stylized image, a target element corresponding to a processing operation for the target region in response to the processing operation for the target region, wherein the target element is an element generated by re-drawing the target region based on an initial element corresponding to the processing operation.

10. The electronic device according to claim 9, wherein in the target element generation method,
the processing operation comprises a selection operation for the target region and a selection operation for the initial element, wherein the initial element is an element to be fused to the target region,
the displaying, in the target region of the stylized image, the target element corresponding to the processing operation for the target region in response to the processing operation for the target region comprises:
in response to the selection operation for the target region on the stylized image, displaying at least one element to be selected;
in response to the selection operation for the initial element from the at least one element to be selected, re-drawing the target region based on the initial element to obtain the target element; and
displaying, in the target region, the target element corresponding to the processing operation.

11. The electronic device according to claim 10, wherein in the target element generation method,
the displaying of the at least one element to be selected in response to the selection operation for the target region on the stylized image comprises:
in response to the selection operation for the target region on the stylized image, identifying content displayed in the target region to obtain an identification result; and
displaying the at least one element to be selected that is related to the identification result.

12. The electronic device according to claim 9, wherein in the target element generation method,
the displaying of the editing page comprises:
displaying an image selection page comprising a plurality of images to be selected, wherein the plurality of images to be selected are images that have been subjected to the target style conversion; and
in response to a selection operation for the stylized image on the image selection page, displaying the editing page comprising the stylized image.

13. The electronic device according to claim 9, wherein in the target element generation method,
the displaying of the editing page comprises:
displaying an image selection page comprising a plurality of images to be selected, wherein the plurality of images to be selected are images that have been subjected to the target style conversion;
in response to a trigger operation for a shooting control in the image selection page, shooting the initial image;
obtaining the stylized image corresponding to the initial image; and
displaying the editing page comprising the stylized image.

14. The electronic device according to claim 12, wherein in the target element generation method,
the displaying of the image selection page comprises:
displaying a target world page, wherein a style of the target world page is associated with the target style; and
in response to a trigger operation for a creation control in the target world page, displaying the image selection page.

15. The electronic device according to claim 13, wherein in the target element generation method,
the obtaining of the stylized image corresponding to the initial image comprises:
determining scene information of the initial image;
transmitting the scene information and the initial image to a target end; and
obtaining, from the target end, the stylized image corresponding to the scene information and the initial image.

16. The electronic device according to claim 9, wherein the target element generation method further comprises:
adding the stylized image with the re-drawn target region to a target world page.

17. A storage medium comprising computer-executable instructions, wherein the computer-executable instructions, when executed by a computer processor, cause the computer processor to execute a target element generation method, comprising:
displaying an editing page on which a stylized image is displayed, wherein the stylized image is an image generated by performing target style conversion on an initial image; and
displaying, in a target region of the stylized image, a target element corresponding to a processing operation for the target region in response to the processing operation for the target region, wherein the target element is an element generated by re-drawing the target region based on an initial element corresponding to the processing operation.
